(19) United States
(12) Patent Application Publication
(10) Pub. No.: US 2013/0090253 A1
(43) Pub. Date: Apr. 11, 2013

(54) ACCURATE QUANTITATION OF BIOMARKERS IN SAMPLES

(71) Applicant: NanoInk, Inc., Skokie, IL (US)

(72) Inventors: Douglas B. Dixon, Deerfield, IL (US); Ivan Ivanov, Itasca, IL (US); Earl J. Gubbins, Vernon Hills, IL (US); Richard R. Harris, Evanston, IL (US); Haris Jamil, Libertyville, IL (US)

(73) Assignee: NANOINK, INC., Skokie, IL (US)

(21) Appl. No.: 13/624,741

(22) Filed: Sep. 21, 2012

Related U.S. Application Data
(60) Provisional application No. 61/538,711, filed on Sep. 23, 2011.

(51) Int. Cl. G01N 1/28

(52) U.S. Cl. CPC G01N 1/286
USPC 506/9; 422/500

(57) ABSTRACT

Methods and apparatus for the accurate quantitation of biomarkers in dried blood spots (DBS), including providing a substrate comprising at least one DBS, wherein the DBS comprises at least one biomolecule distributed on the substrate in a gradient pattern; excising at least one sector-shaped sample from the DBS; and assaying the biomolecule in the sector-shaped sample.

### RELATED APPLICATIONS

This application claims priority to U.S. provisional application Ser. No. 61/538,711 filed Sep. 23, 2011, the complete disclosure of which is hereby incorporated by reference in its entirety.

### BACKGROUND

Dried blood spots (DBS) are used as a method of collecting human blood for use in clinical assays. Easily collected and stored, blood samples on DBS cards are a relatively stable and cost-effective method of sample collection. However, the diffusion of analytes across dried blood spots is not uniform. Analyte distribution is affected by drying as well as the concentration and components of the matrix, creating an analyte concentration gradient from the center to edge of the sample. The standard method of testing samples from DBS cards involves excising circular punches of varying diameters from the DBS sample. Because analytes are not distributed evenly across the card, this sampling method introduces significant variability and bias.

Prior art methods of sampling DBS are described in U.S. Pat. No. 7,819,161; U.S. Pat. No. 7,498,133; U.S. Pat. No. 6,379,318; U.S. Pat. No. 6,171,868; U.S. Pat. No. 5,427,953; U.S. Pat. No. 5,641,682; U.S. Pat. No. 5,211,252; U.S. Pat. No. 5,156,948; US 2011/0158500; US 2011/0133077; US 2011/0132111; US 2011/0129940; US 2010/0286560; US 2010/0010373; US 2008/0268495; US 2004/0101966; US 2003/0039788; WO 2010/043668; WO 2007/098184; WO 2012/027048; El-Hajjar et al., Clinica Chimica Acta, 377(1-2, 2):179-184 (2007); and Tack et al., Journal of the Association for Laboratory Automation, 10(4):231-236 (2005); all of which are incorporated herein by reference in their entireties.

### SUMMARY

Embodiments described herein include methods of making, methods of using, and devices and apparatuses.

To improve upon the variability and bias associated with the prior art DBS sampling methods, embodiments described herein, for example, can take uniform samples radiating from the center to the edge of the DBS, thus producing samples that better represent of the true analyte concentration and that are more consistent with each other.

For example, one embodiment provides a method comprising: providing a substrate comprising at least one DBS, wherein said DBS comprises at least one biomolecule distributed on the substrate in a gradient pattern; excising at least one sector-shaped sample from the DBS; and optionally assaying the biomolecule in the sector-shaped sample.

In one embodiment, the substrate comprises at least one sample deposition area for depositing the DBS. In another embodiment, the substrate is a filter paper. In a further embodiment, the substrate is a Whatman 903 card.

In one embodiment, the DBS is prepared from whole blood. In another embodiment, the DBS is prepared from a synthetic blood matrix. In a further embodiment, the DBS is prepared from a synthetic blood matrix comprising at least one protein carrier.

In one embodiment, the biomolecule is a protein. In another embodiment, the biomolecule is a cytokine. In a further embodiment, the biomolecule is a cytokine which is an IL-1β, an IL-4, an IL-6, an IL-10, or a TNF-α.

In one embodiment, the biomolecule is more concentrated at the center of the DBS than at the periphery. In another embodiment, the biomolecule is more concentrated at the periphery of the DBS than at the center.

In one embodiment, the sector-shaped sample is excised by a sharp cutting tool. In another embodiment, the sector-shaped sample is excised by an adjustable cutting tool.

In one embodiment, the sector-shaped sample is excised radiating from the center to the circumference of the DBS. In another embodiment, the sector-shaped sample consists of a sector bounded by two radii and an arc lying between the two radii. In a further embodiment, two or more sector-shaped samples of equal size and shape are excised from the DBS. In yet another embodiment, eight or more sector-shaped samples of equal size and shape are excised from the DBS.

In one embodiment, the step of assaying the biomolecule comprise measuring the amount of the biomolecule. In another embodiment, the step of assaying the biomolecule comprise measuring the amount of the biomolecule, and wherein the amount of the biomolecule is measured in two or more sector-shaped samples.

Another embodiment described here provides a method comprising: providing a substrate comprising at least one dried spot of a bio-fluid, wherein said dry spot comprises at least one biomolecule distributed on the substrate in a gradient pattern; excising at least one sector-shaped sample from the dried spot; and measuring the amount of the biomolecule in the sector-shaped sample.

In one embodiment, the substrate is a filter paper.

In one embodiment, the biomolecule is a protein. In another embodiment, the biomolecule is selected from the group consisting of a nucleic acid, polysaccharide, lipid, vitamin, hormone, and neurotransmitter.

In one embodiment, the bio-fluid is an animal body fluid selected from the group consisting of blood, tear, saliva, lymph, gastrointestinal fluid and urine. In another embodiment, the bio-fluid is selected from the group consisting of plant xylem fluid, plant phloem fluid, and liquid culture of bacteria.

In one embodiment, the biomolecule is more concentrated at the center of the dried spot than at the periphery. In another embodiment, the biomolecule is more concentrated at the periphery of the dried spot than at the center.

In one embodiment, the sector-shaped sample is excised by a sharp cutting tool.

In one embodiment, the sector-shaped sample consists of a sector bounded by two radii and an arc lying between the two radii.

In one embodiment, two or more sector-shaped samples of equal size and shape are excised from the dried spot.

A further embodiment described here provides an apparatus for excising at least one sample from a DBS, comprising: a punch plate comprising at least two cutting arms meeting each other at an anchor point; a die plate on top of said punch plate comprising an aperture for said cutting arms to pass through; an alignment sheet on top of said die plate comprising a sample aligner directly above said cutting arms and said aperture; and wherein said DBS is securely placed between the die plate and the alignment sheet and aligned with said sample aligner, and wherein the die plate can be pressed toward the punch plate allowing said cutting arms to pass through said aperture and excising said DBS.

In one embodiment, the punch plate comprises a sufficient number of cutting arms meeting each other at the anchor point to cut the DBS into three, four, five, six, eight, ten or twelve sectors of equal size.

In one embodiment, the cutting arms are made of metal, polymer, or silicon-based material. In another embodiment, the cutting arms are made of steel. In a further embodiment, the alignment sheet is made of polycarbonate.

In one embodiment, the aligner comprises at least one outer ring centered at the anchor point. In another embodiment, the aligner comprises at least one outer ring and at least one inner ring both centered at the anchor point, wherein the outer ring and the inner ring are concentric.

In one embodiment, the punch plate further comprises at least one cutting skirt connecting the at least two cutting arm. In another embodiment, the punch plate further comprises at least one arc-shaped cutting skirt connecting the at least two cutting arm.

Another embodiment provides a method comprising: providing a substrate comprising at least one dried blood spot (DBS), wherein said DBS comprises at least one biomolecule distributed on the substrate in a non-uniform pattern; excising at least one sector-shaped sample from the DBS; and optionally, assaying the biomolecule in the sector-shaped sample.

Another embodiment provides a method comprising: providing a substrate comprising at least one dried spot of a bio-fluid, wherein said dry spot comprises at least one biomolecule distributed on the substrate in a non-uniform pattern; excising at least one sector-shaped sample from the dried spot; and measuring the amount of the biomolecule in the sector-shaped sample.

Another embodiment provides a method comprising: evaluating at least one biomolecule disposed on a substrate, wherein the evaluation is carried out on at least two sector-shaped portions of the substrate of approximately equal size.

At least one advantage for at least one embodiment includes more accurate and/or reproducible measurements in assays, for example, evaluation of dried blood spots.

### BRIEF DESCRIPTION OF THE DRAWINGS

FIG. 1 shows, in one embodiment, a top view of a DBS to be sampled by the methods described here. The DBS are divided into multiple (eight) sectors of equal size, and one or more of said sectors can be excised for assaying.

FIG. 2 shows, in one embodiment, a top view of a DBS sampled by prior art methods—one or more circular punches of a fixed diameter are taken from the DBS.

FIG. 3 shows, in one embodiment, a top view of a Whatman 903 card sampled by prior art methods—one or more circular punches of a fixed diameter are taken from the DBS.

FIG. 4 shows, in one embodiment, a schematic view of a DBS sampled by the methods described here—the DBS is divided into eight sample areas of equal size and shape.

FIG. 5 shows, in one embodiment, a schematic view of a DBS sampled by the methods described here—the DBS is divided into six sample areas of equal size and shape plus a remainder area.

FIG. 6 shows, in one embodiment, a top view of different shaped samples described in this application.

FIGS. 7A-7C show, in one embodiment, the accuracy and precision of the methods described here in measuring the true concentration of cytokines in DBS (FIG. 7A: Run 1; FIG. 7B: Run 2; FIG. 7C: Run 3).

FIG. 8 shows, in one embodiment, an apparatus described here for excising sector-shaped samples from DBS. (All dimension in inches; Material: 1 at 1/16″ thick polycarbonate, 1 at ⅛″ thick polycarbonate; Each design—cut through material shown in the graphic, concentric circles cut into material just to mark (0.005″ to 0.025″).)

FIG. 9 shows, in one embodiment, basic operation of an apparatus described here for excising the sector-shaped samples from DBS.

FIG. 10 shows, in one embodiment, major piece parts of an apparatus described here for excising the sector-shaped samples from DBS.

FIG. 11 shows, in one embodiment, basic assembly of an apparatus described here for excising the sector-shaped samples from DBS.

FIG. 12 shows, in one embodiment, a top view of a DBS sampled by taking circular punches of a fixed diameter in the center and one periphery area of the DBS. (Standard samples prepared in RBC's+PBS-BSA.)

FIG. 13 shows, in one embodiment, a comparison of the amounts of cytokines detected in the center and one periphery area of the DBS. (To test the distribution of cytokines on DBS cards in the absence of cells, cytokine standards were prepared in blocking buffer, spotted onto DBS cards, dried and eluted according to standard procedures.)

FIG. 14 shows, in one embodiment, a top view of a DBS sampled by taking circular punches of a fixed diameter in the center and two periphery areas of the DBS. (Periphery samples are taken from a ring equidistant from the center to decrease variability.)

FIG. 15 shows, in one embodiment, a comparison of the amounts of cytokines detected in the center and two periphery areas of the DBS. (DBS punches for standards taken from periphery; grayed area represents 65%-135% acceptance range)

FIG. 16 shows, in one embodiment, the effect of serum on cytokine distribution in DBS. (DBS matrix prepared with Human Serum in place of PBS-BSA)

### DETAILED DESCRIPTION

### Introduction

Dried blood spots (DBS) are used as a sample collecting method for a number of important clinical assays as well as research-related studies. During sample collection, drops of whole blood are collected, generally by either finger or heel-stick, and placed in contact with purpose-made filter paper cards (e.g., Whatman—903 “Proteinsaver” cards) and the blood components then spread through the filter paper. When done correctly, the blood sample is applied to the center of a pre-marked circular collection area on the Whatman 903 card. As the sample is collected, it spreads through the filter paper from the center to the edge of the DBS. Once the sample is collected on the card, the blood is allowed to dry at room temperature, and the collection card is stored at −20° C. or lower with dessicant to preserve the integrity of the sample. During the initial spreading and subsequent drying process, components in the serum migrate as the blood dries on the card. Additionally, it is likely that some components of the blood may associate specifically with proteins in the sample causing them to migrate through the filter paper in tandem with those components. As a result, many analytes in the serum or plasma will dry in a gradient pattern, less concentrated at the center and more concentrated as you approach the periphery of the dried blood spot or, in some cases, vice-versa depending on the matrix being used. Non-uniformity in the placement of the molecules over the surface is a problem.

It is also known that a “synthetic blood” matrix is frequently created for DBS. Commonly, washed red blood cells are resuspended in aqueous buffer (PBS or similar) with the addition of a protein carrier like bovine serum albumin in the place of the serum component. The overall protein concentration and make-up of a buffer-containing matrix are quite different from that of whole blood.

Surprisingly, different DBS matrix components can significantly alter the distribution pattern of protein biomarkers such as cytokines on the DBS filter card, with biomarkers in a buffer-containing matrix migrating quite differently from those in a serum containing matrix or whole blood.

For some assay methods using DBS samples (e.g., HIV testing by PCR), a simple “positive or negative” result is sufficient and an accurate analyte concentration is not critical. For many other assay methods, however, a more quantitative result is required. Independent of the testing method employed, the “state of the art” for sampling from DBS cards involves taking circular punches of a fixed diameter from the DBS card and eluting analytes from the card punch using either aqueous buffers or organic solvents. Frequently more than one punch is taken from the DBS sample; this is generally done either for replicate testing or for testing the same sample in more than one assay. Under conditions where multiple punches are needed for replicates, and/or where quantitative results are required, the distribution of the analytes and placement of the punch within the DBS sample becomes a critical variable. For example, because of the gradient-like distribution of analytes, replicate punches taken from the center and periphery of a DBS sample may exhibit quite different analyte concentrations when tested in a clinical assay. Similarly, the results obtained from testing a single punch from a DBS sample may not be representative of the samples actual analyte concentration. In either case, taking test samples in this manner can lead to significant variability and erroneous assay results.

To correct for the variability in analyte distribution through the DBS sample and more consistently attain a reproducible sample that better represents the average analyte concentration, the simplest solution would be to analyze the entire DBS sample. This solution is, however, not practical in most cases. Therefore, an approach that allows multiple samples to be taken from a single DBS sample each of which has an equivalent concentration of analyte while also being as representative of the average analyte concentration as possible would be optimal. According to a preferred embodiment of the present application, for standard circular DBS, multiple samples are taken by cutting equal sectors or “pie-shaped” wedges from the DBS sample with the point at the circles center ending at the circles edge. The number of sectors or wedges can be dictated by the number of replicates needed, the elution method employed, and the concentration of analyte in the sample. Analytes in low abundance would likely require a larger sample area. A sample taken in this way, once eluted, would provide a measure of the concentration of the analyte across the entire concentration gradient, and would also allow accurate replicate samples to be acquired.

### Bio-Fluid

Dried spots of bio-fluids can be sampled and assayed according to the methods described here. In one embodiment, for example, the bio-fluid is human or animal body fluid, including blood, tear, saliva, lymph, gastrointestinal fluid, urine, etc. In another embodiment, the bio-fluid is plant fluid, including xylem fluid, phloem fluid, etc. In a further embodiment, the bio-fluid is a liquid culture of bacteria.

In a preferred embodiment, the bio-fluid of the present application is human whole blood, including blood from a new born baby. In another preferred embodiment, the bio-fluid is a synthetic blood matrix. A synthetic blood matrix can be prepared by resuspending washed red blood cells in an aqueous buffer (e.g., PBS, etc.), and adding at least one protein carrier (e.g., BSA, etc.). The synthetic blood matrix would have an overall protein profile different from that of whole blood.

Methods for preparing synthetic blood matrix is known in the art and described in, for example, McDade et al, Clin. Chem., 50:652-654 (2004), which is incorporated herein by reference in its entirety.

### Biomolecule

Any biomolecule in a bio-fluid can be assayed or measured according to the methods described here. In one embodiment, the biomolecule is a protein. In another embodiment, the biomolecule is a nucleic acid such as DNA or RNA. In a further embodiment, the biomolecule is a polysaccharide. In yet another embodiment, the biomolecule is a lipid. Other embodiments of the biomolecule include vitamin, hormone, and neurotransmitter.

The methods described here are particularly efficient and accurate in measuring the true concentration of biomolecules that are distributed on a substrate in a gradient pattern. Many biomolecules are known to exhibit this behavior in dry spots on an absorbent filter paper such as Whatman 903 card, including various cytokines (e.g., IL-1b, IL-4, IL-6, IL-10, TNF-a, etc). While some of these biomolecules may be more concentrated at the center of the DBS, other may be more concentrated at the periphery. For biomolecules with unknown distribution patterns in dry spots, their distribution pattern can be readily determined by one of skill in the art following the method of Example 1.

### Substrate

Any substrate suitable for receiving bio-fluid such as blood can be used for the methods described here. In one embodiment, the substrate is a filter paper. Standard, commercial substrates can be used. Regulatory issues may encourage use of standard substrates in the relevant industry. In a preferred embodiment, the substrate is a Whatman 903 card. In another embodiment, the substrate is a Guthrie card. In a further embodiment, the substrate is a Ahlstrom 226 filter paper. In yet another embodiment, the substrate is a CoreMedica biodisk.

In one embodiment, the substrate comprises one or more sample deposition areas for receiving bio-fluid such as blood. The substrate may further comprise a cover for protecting the sample deposition areas before and after sample collection. In another embodiment, the substrate comprises a unique sequential number or bar code. In a further embodiment, the substrate comprises a demographic portion for inputting information relating to the collection of bio-fluid such as blood. In yet another embodiment, the substrate comprises one or more circular areas for sample deposition, the diameter of the circular areas can be, for example, 0.1-1 inch, or 0.25-0.75 inch, or about 0.5 inch.

### Dried Blood Spot

The preparation of DBS is known in the art and described in detail in, for example, ACTN Laboratory Technologist Committee, ACTN Dried Blood Spots Procedure, Version 1.1 (11 Mar. 2009), which is incorporated herein by reference in its entirety.

In one embodiment, DBS can be prepared by applying onto a filter paper a few drops of blood from a finger, heel or toe. The amount of blood applied can be 50-100 ul, or 60-90 ul, or 75-80 ul. Then blood can be allowed to saturate the paper and can be dried in air for a plurality of hours, for example (e.g, about two or three hours). Before sample excision, DBS can be stored in, for example, low gas-permeability plastic bags at, for example, −20° C. Desiccant can be added to reduce humidity.

### Sector-Shaped Sample

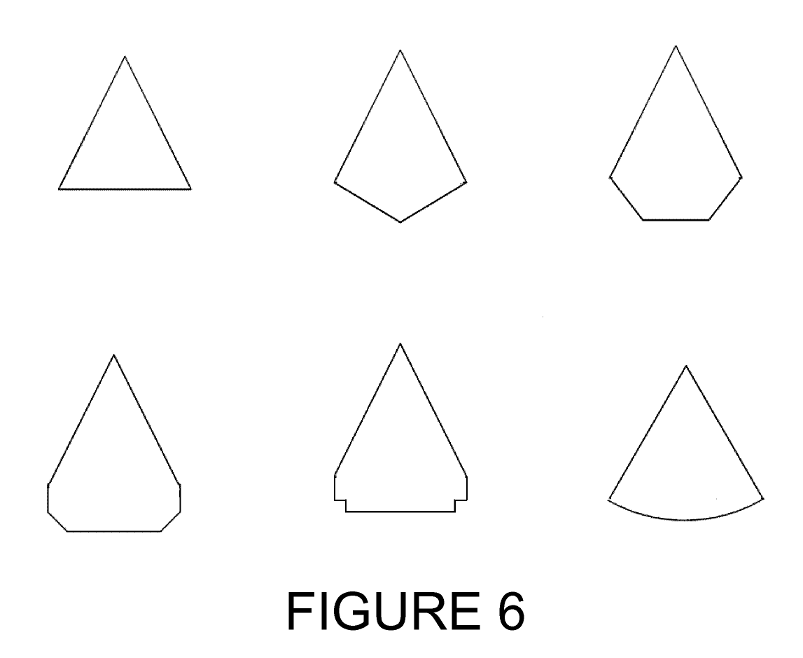

A sector-shape sample described here can be defined as an area bounded by two radii radiating from the same anchor point and an outer boundary connecting the two radii, wherein the anchor point of the sector-shaped sample is defined as the point where the two radii meet, wherein said area is sufficiently large that, when the anchor point is placed at the center of a DBS, said area encompasses an entire portion of the DBS lying between the two radii. The outer boundary can be, for example, an arc, a straight line, a plurality of inter-connected straight lines, a wave, or any other lines capable of connecting the two radii to form an area encompassing the entire DBS portion lying between the two radii. In one embodiment, the sector-shaped sample is a geometrical sector consisting of an area bounded by two radii and an arc lying between the two radii. In another embodiment, the sector-shaped sample is not a geometrical sector, but a polygon such as a triangle or a quadrilateral. Non-limiting examples of the sector-shaped samples are illustrated in, for example, FIG. 6.

Excising Sector-Shaped Samples from the Dried Blood Spot

Known methods for sampling from DBS cards can involve taking one or more circular punches of a fixed diameter from the DBS card. See, for example, U.S. Pat. No. 6,171,868, U.S. Pat. No. 5,862,729, U.S. Pat. No. 5,641,682, and U.S. Pat. No. 5,638,170, all of which are incorporated herein by reference in their entireties.

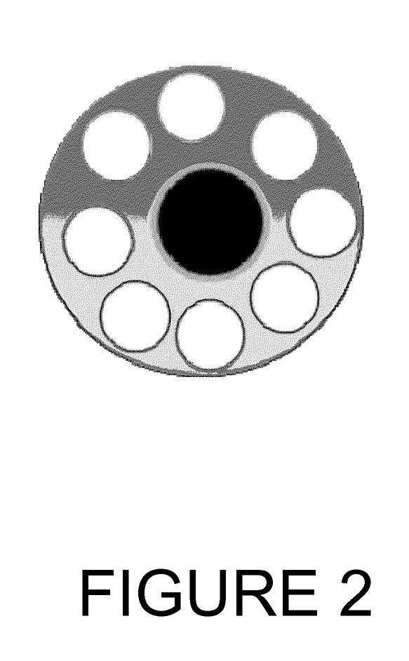

In order to obtain multiple samples which, when eluted and assayed, would provide reproducible results, samples can be taken from the periphery of the blood spot equidistant from the edge of the sample (FIG. 2). Assuming that the blood drop spreads from the circles center to the edge, the concentration of analytes in punches taken in concentric rings around the center should be equivalent. Taking samples around the edge of the dried blood spot equidistant from the spots edge would allow the maximum number of equivalent samples to be taken. However, because the analytes distribute in a gradient pattern through the blood spot, samples taken around the edge may not provide an accurate measurement of the actual analyte concentration in the blood itself.

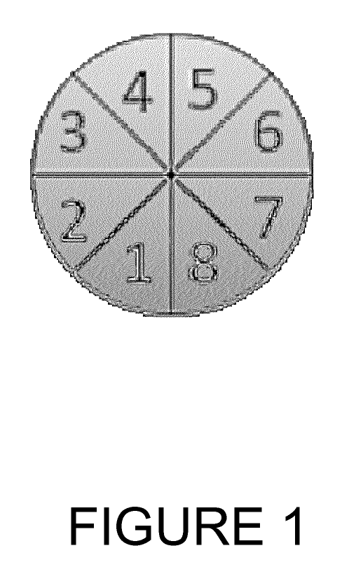

To most precisely obtain reproducible samples for assay from a circular DBS, the results of which, when assayed, would provide analyte concentration values that most accurately represent the original blood concentration, a sector-shaped sample (e.g., an exemplary “pie-shaped” wedge shown in FIG. 1) should be taken rather than a circular punch. Because of the center-to-periphery gradient pattern created during sample spreading and drying, a sample taken employing this method would give the most accurate cross-section of sample representing the entire concentration gradient. In addition, two or more samples of this type of equal size and shape taken from the same sample should also provide the most reproducible results when replicate samples are required.

In order to obtain samples of this type, one method would be to measure and excise equal sector-shaped pieces using a sharp cutting implement such as an x-acto knife or similar device, with the number of pieces determined by the size of sample necessary for measuring any given analyte (based on its relative concentration). Another method would be to use a (purpose-made) adjustable cutter that could be aligned around the circumference of the blood spot, or with the center of the blood spot, which would then cut the sample into multiple sector-shaped pieces of equal size. The number of equivalent sector-shaped pieces should be variable to adjust for sampling needs and sample size.

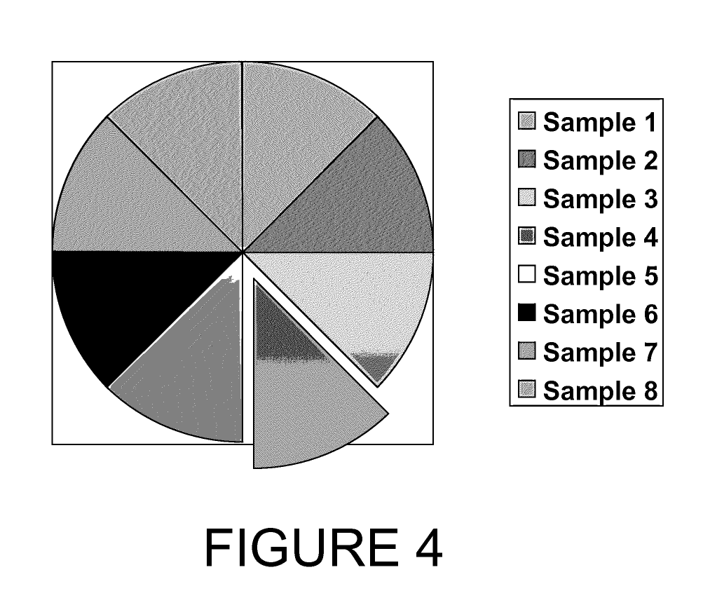

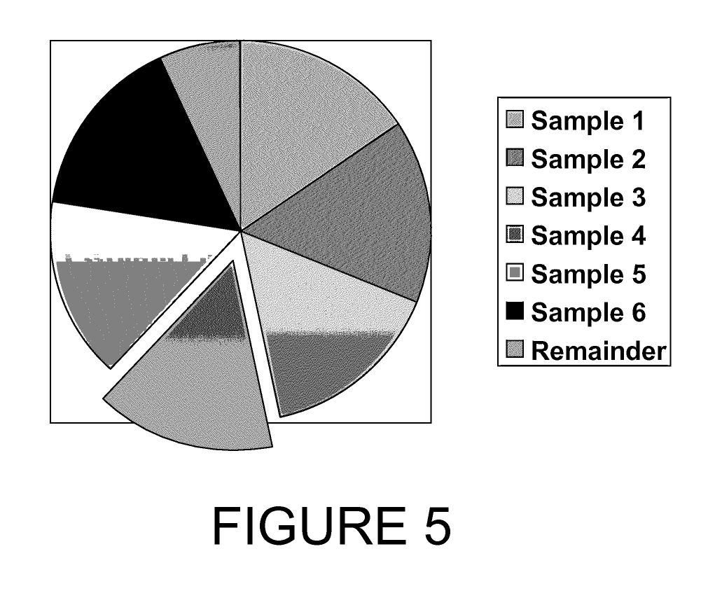

The sector-shaped sample can be a geometrical sector consisting of an area bounded by two radii and an arc lying between the two radii. In one embodiment according to FIG. 4, a circular DBS on the substrate is perfectly divided into multiple sectors of equal size, wherein one or more of said sectors are excised and assayed. In one embodiment according to FIG. 5, a circular DBS on the substrate is divided into multiple sectors of equal size plus a remainder of a different size, wherein one or more of said equal-sized sectors are excised and assayed.

### Apparatus for Excising Sector-Shaped Samples

A sharp cutting tool can be used for excising sector-shaped samples according to the methods described here. The sharp cutting tool can be a (purpose-made) adjustable cutting tool that could be aligned around the circumference of the blood spot, or with the center of the blood spot, which would then cut the sample into multiple sector-shaped pieces of equal size.

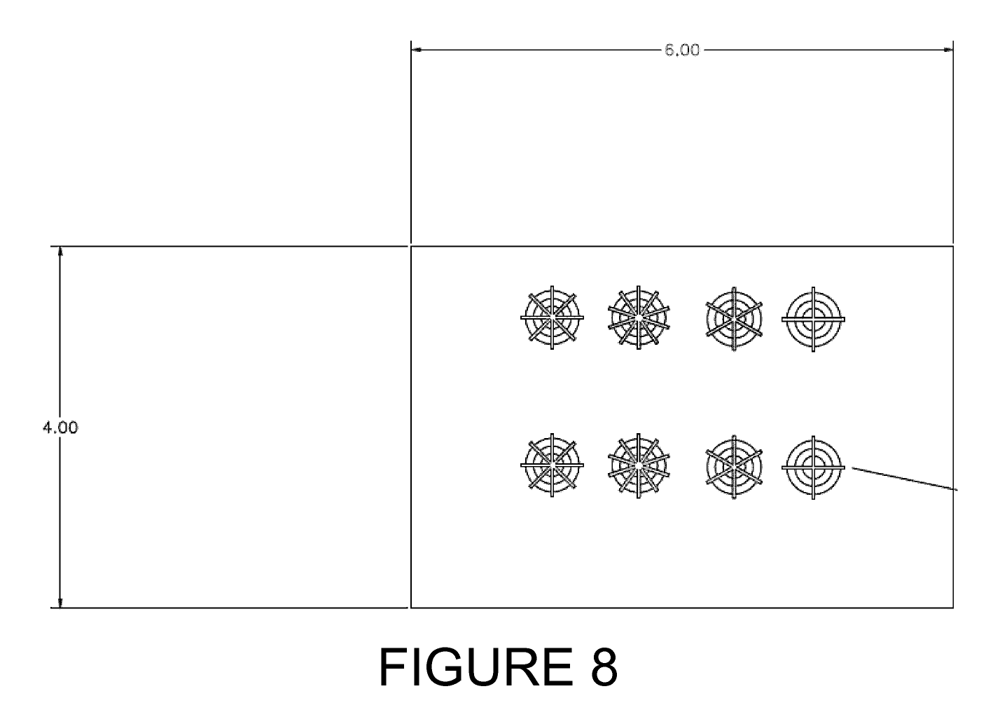

FIGS. 8-11 show major piece parts, basic assembly, and basic operation of an embodiment for an apparatus for excising sector-shaped samples from DBS. Other embodiments can be used. The major piece parts of the apparatus include, for example, a punch, a die, and an alignment sheet. In a particular embodiment, the major piece parts of the apparatus include a steel punch plate, a steel die plate, and a Lexan polycarbonate alignment sheet. A DBS card is positioned between the polycarbonate alignment sheet and the steel die plate using rings on the polycarbonate alignment sheet to position the DBS evenly over the punch, in order to cut equal sized samples from the DBS. Once aligned, the polycarbonate alignment sheet is held down to hold the DBS card in place, and the polycarbonate alignment sheet/steel die plate combination are pressed down over the steel punch plate to cut the DBS card segment. Because of the possible variability of the DBS diameter, a second step is optionally taken to separate the cut segments totally from the DBS card. This second step may involve using a circle punch with a diameter chosen to correspond to the diameter of a particular DBS. This is one embodiment; other embodiments are possible.

The apparatus may comprise a sufficient number of cutting arms perfectly dividing a target area into any number of sectors of equal size. For example, the cutting arms may divide the target area into three, four, five, six, eight, ten or twelve sectors of equal size. The cutting arms can be made of any material that is suitable for making sharp cutting tools. For example, the cutting arms can be made of metal, polymer, or silicon-based material. In one embodiment, the cutting arms are made of steel. Each cutting arm is adapted to cut along a straight line on the DBS starting from the center of the DBS and extending beyond the circumference thereof. The length of the cutting arm can be, for example, about 0.1-0.5 inch, about 0.2-0.4 inch, or about 0.3 inch.

Alternative, in addition to the cutting arms, the punch plate may also comprise at least one cutting skirt connecting at least two cutting arms. The cutting skirt may be of any shape, as long as the cutting arms and the cutting skirt are capable of operating together to excising a sector-shaped sample from the DBS. In one example, the cutting skirt is a circular punch with a diameter chosen to correspond to the diameter of a particular DBS. In cases that the punch plate of the apparatus comprise both the cutting arms and the cutting skirts, additional steps for separating the cut segments from the DBS card may not be necessary.

As shown in FIG. 8, the alignment sheet can be a Lexan polycarbonate alignment sheet. The alignment sheet comprises an aligner comprising a plurality of arms corresponding to the cutting arms on the punch plate, and at least one outer ring for marking the DBS sample for excising. The diameter of the outer ring can be, for example, 0.1-1 inch, or 0.25-0.75 inch, or 0.4-0.6 inch, or about 0.5 inch. The alignment sheet may further comprises at least one inner ring, wherein the outer ring and the inner ring are concentric.

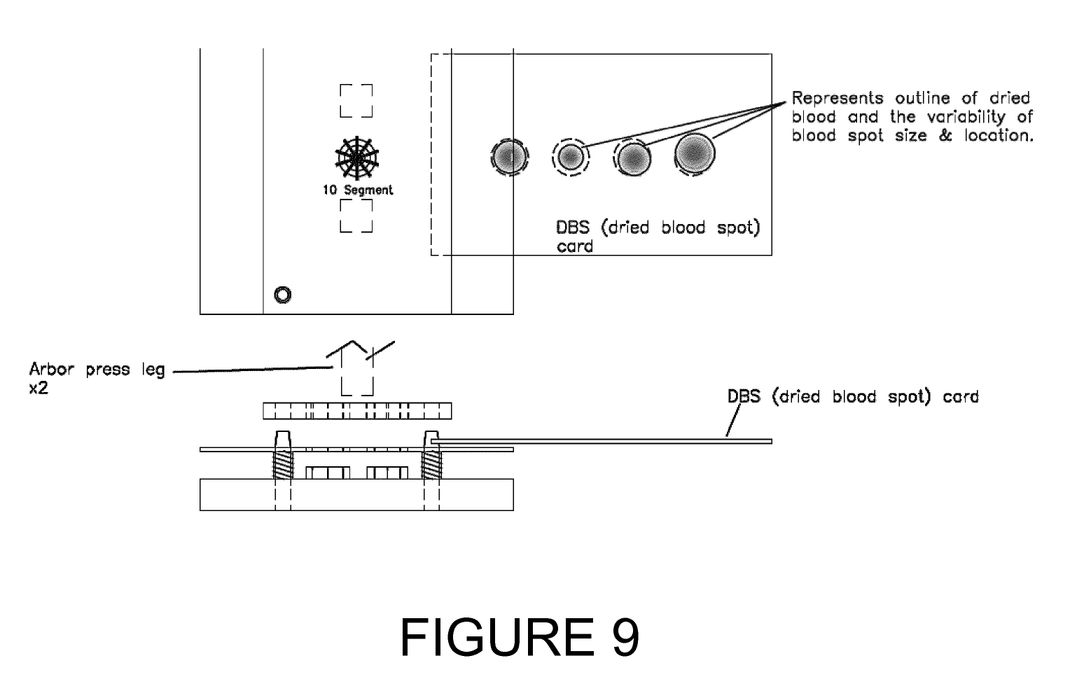

In a particular embodiment, as shown in FIGS. 9-11, the major piece parts of the apparatus include a steel punch plate (10), a steel die plate (20), and a Lexan polycarbonate alignment sheet (30). The punch plate (10) comprises multiple cutting arms (12) meeting each other at an anchor point (14). The die plate (20) comprises an aperture (22) and is configured to be placed on top of the punch plate (10) such that the cutting arms (12) pass through the aperture (22). The alignment sheet (30) comprises a sample aligner (32) and is configured to be placed on top of the die plate (20) such that the sample aligner (32) is disposed directly above the cutting arms (12) and the aperture (22). The sample aligner (32) comprises an outer ring (34) and an inner ring (36) which are concentric. The punch plate (10), the steel die plate (20) and the alignment sheet (30) are configured such that a substrate comprising DBS is securely locatable between the die plate (20) and the alignment sheet (30) aligned with the sample aligner (32), and that the die plate (20) and the punch plate (10) are movable toward each other such that the cutting arms (12) pass through the aperture (22) to excise samples from the DBS.

One embodiment, thus, provides an apparatus for excising at least one sample from a dried blood spot (DBS), comprising: a punch plate comprising at least two cutting arms meeting each other at an anchor point; a die plate comprising an aperture, the die plate being configured to be placed on top of said punch plate such that the cutting arms pass through the aperture; an alignment sheet comprising a sample aligner, the alignment sheet being configured to be placed on top of said die plate such that the sample aligner is disposed directly above said cutting arms and said aperture, wherein said apparatus is configured such that (i) said DBS is securely locatable between the die plate and the alignment sheet aligned with said sample aligner, and (ii) the die plate and the punch plate are movable toward each other such that said cutting arms pass through said aperture and excise said sample from said DBS.

### Assaying the Biomolecule

The assay/measurement of biomolecules in a sample is known in the art and described in detail in Parker and Cubitt, J. Clin. Pathol. 52 (9):633-9, 1999, Alberts et al., Molecular Biology of the Cell, 5^{th} Ed., 2007, and Lodis et al., Molecular Cell Biology, 5^{th} Ed., 2007, all of which are incorporated herein by reference in their entireties. The assay/measurement of biomolecules described here comprises any biochemical or biophysical tests known in the art.

In one embodiment, the sector-shaped sample excised from DBS is disposed into the filter portion of a microcentrifuge spin-filter unit. A elution buffer (NanoInk blocking buffer) is added into the filter unit. After shaking and incubation, the filter portion is transferred into a clean microcentrifuge tube. After spinning, the filter unit and the sector-shaped card are discarded, and the eluates are stored at −20° C. or below for subsequent testing.

In another embodiment, the sector-shaped sample excised from DBS is disposed into a flat bottomed microtitre plate. Then phosphate buffered saline containing 0.05% Tween 80 and 0.005% sodium azide can be used to elute out the blood, overnight at 4° C. The resultant plate containing the eluates can be used as the “master”, and dilutions can be made from the “master” for subsequent testing.

In addition, dip-pen nanolithography (DPN) can be used in the process of assaying/measuring the biomolecules. DPN methods are described in, for example, U.S. Pat. No. 6,635,311, U.S. Pat. No. 6,827,979, and U.S. Pat. No. 7,744,963, all of which are described herein by reference in their entireties.

Additional embodiments are provided in the following examples and working examples.

### EXAMPLES AND WORKING EXAMPLES

### Comparative Example 1

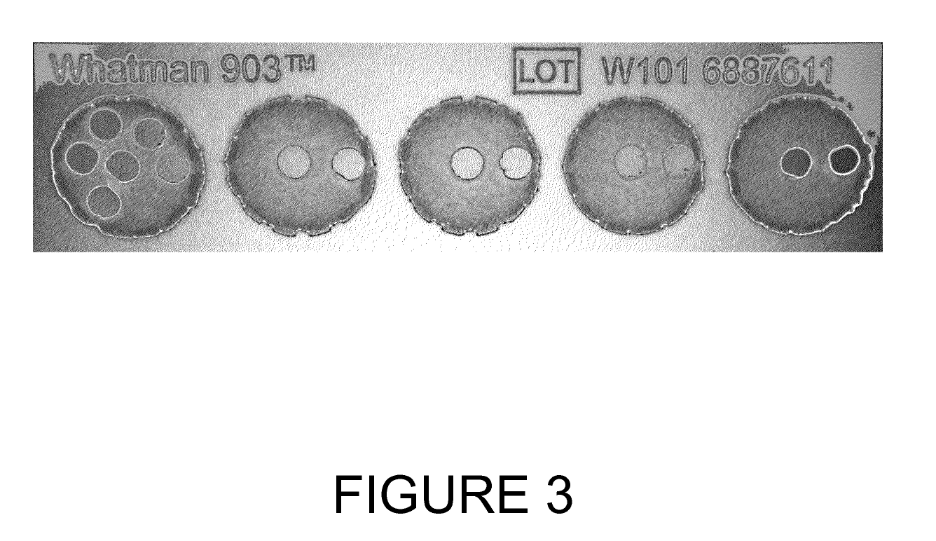

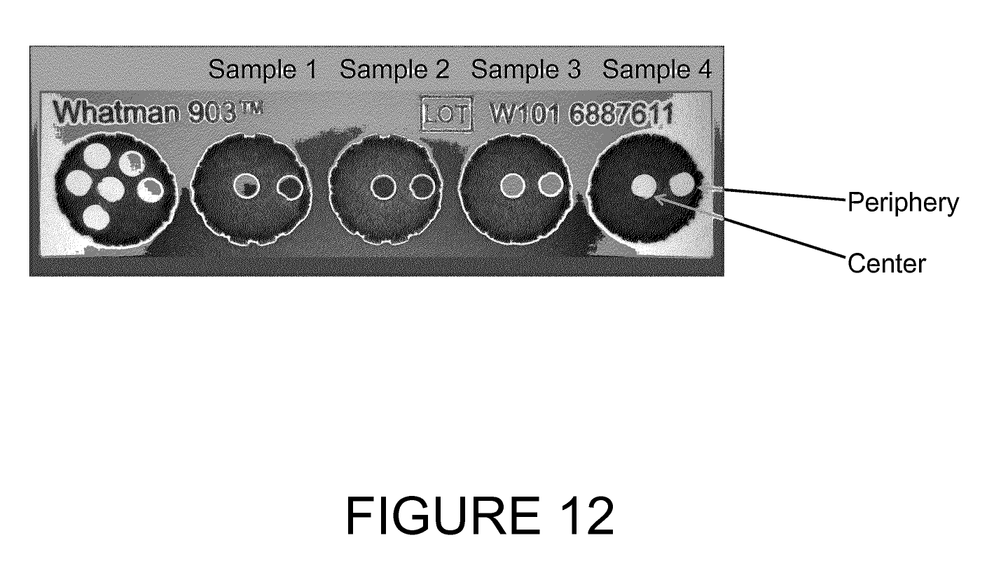

This experiment compared the cytokine concentrations of center and peripheral punches in DBS standard samples eluted from Whatman 903 blood cards (e.g., see FIGS. 3 and 12). The samples were prepared and eluted according to the following procedures:

### Preparation of DBS Cytokine Standards and QC Samples

### Reagents:

1. 40 mls washed human erythrocytes (RBC's) in Alsever's solution. (Valley Biomedical, Inc. Winchester, Va., Cat. #RC1026)
2. Pooled human serum (Bioreclamation, LLC., Cat. #HRSRM)
3. Phosphate buffered saline (PBS)+0.5% bovine serum albumin

### 4. Normal Saline (0.9% NaCl)

5. Recombinant cytokine stocks
6. Whatman 903 Protein Saver DBS cards.

### Procedure:

1. Distribute the red blood cells equally between 2-50 ml conical tubes. Bring volume up to 50 ml with normal saline and mix gently by inverting tubes. Cap tubes tightly.
2. Spin tubes in centrifuge with swinging bucket rotor for 5 minutes at 2,750 rpm, 4° C.
3. Gently remove supernatant from loosely packed RBC “pellet” by vacuum.
4. Resuspend cells up to 50 ml in normal saline by gently inverting tube.
5. Repeat spin (step 2)
6. At completion of spin gently remove supernatant by vacuum.
7. Resuspend each pellet in approximately 10 ml normal saline by inverting tube and transfer resuspended red cells to 2-15 ml conical tubes.
8. Bring volume up to 15 ml with normal saline and invert tubes to mix.
9. Repeat spin (step 2).
10. Remove supernatant gently by vacuum. (Final supernatant should be clear with no visible hemoglobin).
11. Measure pellet volume using markings on side of tube. Add equal volume of pooled human serum or PBS+0.5% BSA to pellet and gently resuspend cells by inverting tube. Mix well. (This results in a “synthetic blood” mixture with approximate hematocrit of 50%)
12. Aliquot resuspended RBC's according to predetermined dilution scheme. Spike most concentrated standard with concentrated cytokine mixture and mix gently by inversion.
13. Prepare standards and QC samples by serial dilution. All samples should be mixed thoroughly by gentle inversion at each step.
14. After all Standards and QC samples have been prepared, carefully pipet 50 ul of the RBC cytokine mixture onto each spot of the DBS card. Pipet into the center of the spot, allowing the mixture to spread to the periphery. Fill as many spots as possible on each card.
15. After all cards have been prepared, allow the cards to air dry for at least 4 hours in a controlled humidity environment.
16. Once DBS cards have dried, place them in a sealed zip-lock bag with desiccant and store at −20° C. until use.

### DBS Sample Elution Protocol

Note: Whatman 903 DBS cards containing blood samples can be stored at −20° C. in a sealed bag or container containing desiccant.
1. Prior to elution, remove DBS cards from storage and allow to come to room temperature in the sealed bag containing desiccant for 30-60 minutes to avoid the formation of condensation.
2. Using a 3 mm punch apparatus, take punches from the DBS samples being certain to take the entire punch from a fully saturated area of the filter. In addition, if samples are to be compared (i.e. for standards or replicates) be certain to take all punches from areas of the DBS spot that are equidistant from the edge of the actual blood spot.
3. Remove the filter unit and place 50 μl of buffer or water in the bottom of the microcentrifuge tube to decrease evaporation. Replace the filter unity and place the DBS card punches into the filter portion of a microcentrifuge spin-filter unit (Millipore 1.5 ml UFC3-0DV-00 or equivalent). Carefully and accurately pipet elution buffer (Nanolnk blocking buffer) onto the punch in the filter unit. The standard elution volume is 25 μl/3 mm punch.
4. Close top of microcentrifuge tube and seal with parafilm.
5. Place tubes in shaker for 6 hours @ 4° C. (shaker setting: 1400 rpm)
6. After incubation, unseal tubes and transfer filter portion to clean labeled microcentrifuge tube.
7. Spin tubes at 12,000 rpm×5 minutes @ 4° C.
8. Discard filter unit and eluted punch. Close tubes and store at −20° C. until use.

### 48-Well Assay Protocol

1. A sample slide is positioned face-up into the 48-well apparatus.
2. 4 μl/well *blocking buffer placed in the wells on the sample slide.
3. The nanoarray slide is carefully placed on top with printed side down and incubated for 1 hour @ RT.
4. Block is removed from BOTH nanoarray and sample slide by vacuum using the vacuum device.
5. 4 μl of the Cytokine Standard Curve mixture or samples are applied to blocked sample slide.
6. The nanoarray slide is carefully placed onto the samples and incubated for 3 hours @ RT.
7. The nanoarray slide is carefully removed and washed with *wash buffer 5 times (3 ml/wash) using a pipette over a sink or container, then placed into the incubation apparatus and washed an additional 5 times with wash buffer and removed by vacuum.
8. Detection antibody mixture is diluted in block (2 mls) and pipetted into the bulk apparatus and incubated 1 hour @ RT with gentle shaking.
9. Detection antibody mixture is removed from the incubation apparatus by vacuum and slide is washed 5× with wash buffer, again removing wash buffer by vacuum.
10. Alexa-Fluor 647-streptavidin conjugate (Invitrogen cat. No. 521374) is diluted in block (1 ug/m 1) and pipetted into the incubation apparatus and incubated @ RT for 30′ with gentle shaking.
11. Streptavidin conjugate is removed by vacuum and slide is washed 5× with wash buffer followed by a bulk wash in wash buffer and then ddH2O (in 50 ml conical test tube).
12. Slide is spun-dry and scanned.

### *Block=Bio-Rad PBS/casein Blocker cat no. 161-0783

*Wash Buffer=PBS with 0.1% Tween-20

### Characterization

For these experiments, cytokine-spiked blood samples were prepared as described. 3 mm punches were taken from the DBS cards either from the center of the blood spot or the periphery of the blood spot (see 4 blood spots on the right of the FIG. 3). These samples were then eluted according to the Sample Elution protocol above and the eluted samples were run on Nanolnk's 48-well assay slide. Slides were then read in an Innopsys scanner and cytokine concentrations were determined by Relative Fluorescent Unit (RFU) values. Higher RFU values denote the presence of more cytokine, lower RFU values reflect lower concentrations of cytokine in the sample.

### Results

TABLE 1
Assay Results, RBC's + PBS-BSA
RFU Results

| | Sample 1 | | Sample 2 | | Sample 3 | | Sample 4 | |
|---|---|---|---|---|---|---|---|---|
| | Center | Periphery | Center | Periphery | Center | Periphery | Center | Periphery |
| IL-1b | 1901 | 2843 | 1925 | 2692 | 1965 | 2451 | 1997 | 2677 |
| IL-4 | 4256 | 1582 | 4108 | 1144 | 4384 | 1182 | 4971 | 1381 |
| IL-6 | 1706 | 925 | 1381 | 645 | 1106 | 643 | 1365 | 856 |
| IL-10 | 2186 | 2325 | 2456 | 2276 | 2369 | 2413 | 2355 | 2352 |
| IFNg | 5235 | 2760 | 7318 | 2464 | 7734 | 2686 | 7247 | 2511 |
| TNFa | 1132 | 1288 | 1113 | 1300 | 930 | 1424 | 1202 | 1365 |

Percent signal change from center to periphery

| | Sample | Sample | Sample | Sample | |
|---|---|---|---|---|---|
| | 1 | 2 | 3 | 4 | Average |
| IL-1b | 33 | 28 | 20 | 25 | 27 |
| IL-4 | −169 | −259 | −271 | −260 | −240 |
| IL-6 | −84 | −114 | −72 | −59 | −83 |
| IL-10 | 6 | −8 | 2 | 0 | 0 |
| IFN-g | −90 | −197 | −188 | −189 | −166 |
| TNF-a | 12 | 14 | 35 | 12 | 18 |

TABLE 2
Assay Results, RBC's + Serum
RFU Results

| | 500 pg/ml | | | | 250 pg/ml | | | | 125 pg/ml | | | |
|---|---|---|---|---|---|---|---|---|---|---|---|---|
| | Sample 1 | | Sample 2 | | Sample 1 | | Sample 2 | | Sample 1 | | Sample 2 | |
| | Center | Periph | Center | Periph | Center | Periph | Center | Periph | Center | Periph | Center | Periph |
| IL-1b | 23987 | 32277 | 23997 | 29962 | 18357 | 21833 | 17426 | 20090 | 13167 | 14505 | 12073 | 14003 |
| IL-4 | 16653 | 33030 | 20070 | 26268 | 8870 | 13669 | 9616 | 12195 | 3841 | 5688 | 3781 | 5469 |
| IL-6 | 14422 | 24736 | 13436 | 21813 | 6054 | 10510 | 6046 | 8883 | 2550 | 4662 | 2954 | 4986 |
| IL-10 | 6856 | 13076 | 7003 | 11444 | 3512 | 5817 | 3550 | 5185 | 1593 | 2660 | 1653 | 2363 |
| TNFa | 12773 | 19773 | 12453 | 20326 | 5253 | 9932 | 5709 | 8595 | 1997 | 3763 | 1908 | 3514 |

Recovery Results

| | 500 pg/ml | | | | 250 pg/ml | | | | 125 pg/ml | | | |
|---|---|---|---|---|---|---|---|---|---|---|---|---|
| | Center | Periph | Center | Periph | Center | Periph | Center | Periph | Center | Periph | Center | Periph |
| IL-1b | 63% | 115% | 63% | 99% | 64% | 101% | 56% | 82% | 40% | 60% | 25% | 52% |
| IL-4 | 59% | 148% | 74% | 106% | 58% | 93% | 63% | 82% | 51% | 74% | 50% | 71% |
| IL-6 | 72% | 123% | 67% | 109% | 61% | 105% | 60% | 89% | 50% | 93% | 58% | 100% |
| IL-10 | 61% | 115% | 63% | 101% | 64% | 105% | 65% | 94% | 59% | 98% | 61% | 87% |
| TNF-a | 64% | 100% | 63% | 103% | 58% | 102% | 62% | 89% | 50% | 86% | 49% | 81% |

These experiments clearly showed that:

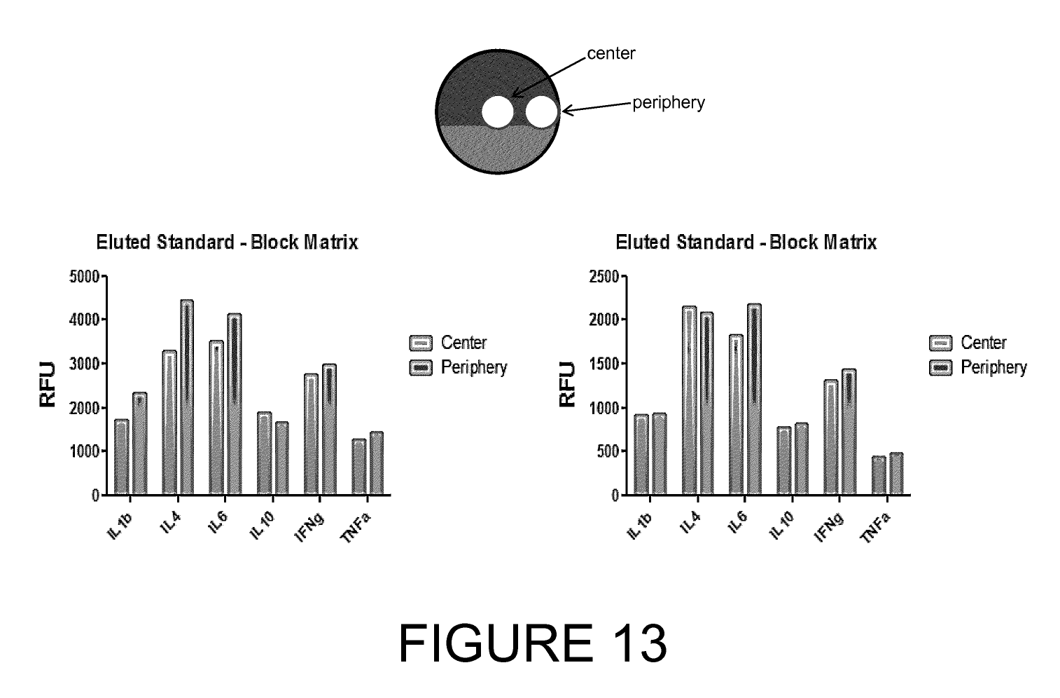

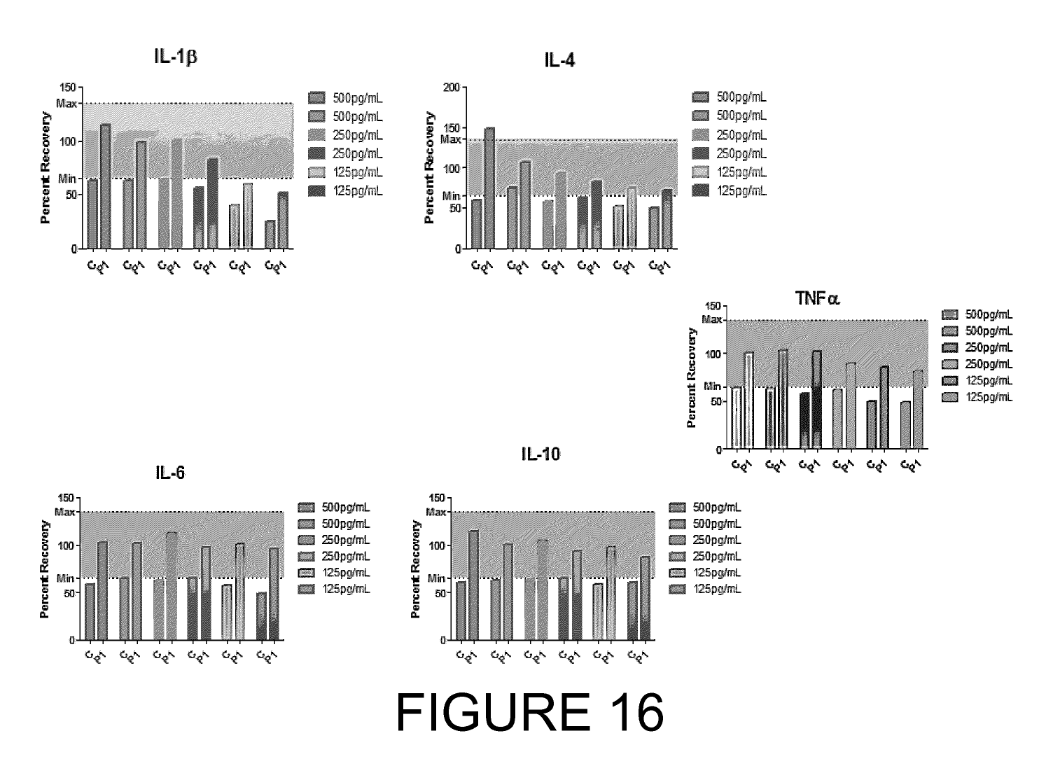

1) Cytokines were distributed unevenly through the blood spot. Samples taken from the center of the blood spots had significantly different concentrations of cytokines than samples taken from the periphery of the blood spot.
2) Cytokines can distribute differently depending on the matrix used for sample preparation. Individual cytokines distribute differently in a matrix of PBS+0.5% BSA, some cytokines at higher concentration in the center of the blood spot, some at higher concentration at the periphery, and some distributing evenly across the blood spot (See Table 1 and FIG. 13). In a serum matrix all cytokines appear to distribute at higher concentrations at the periphery of the blood spot, although the ratio of center to periphery may change depending on the individual analyte (See Table 2 and FIG. 16).

These results lead to the conclusion that the methods used for taking samples from DBS cards for assay can introduce variability and inaccuracy.

### Comparative Example 2

### NanoArray Assay Validation for Dry Blood Spot Samples

Example 2 provides further context for the new embodiments.

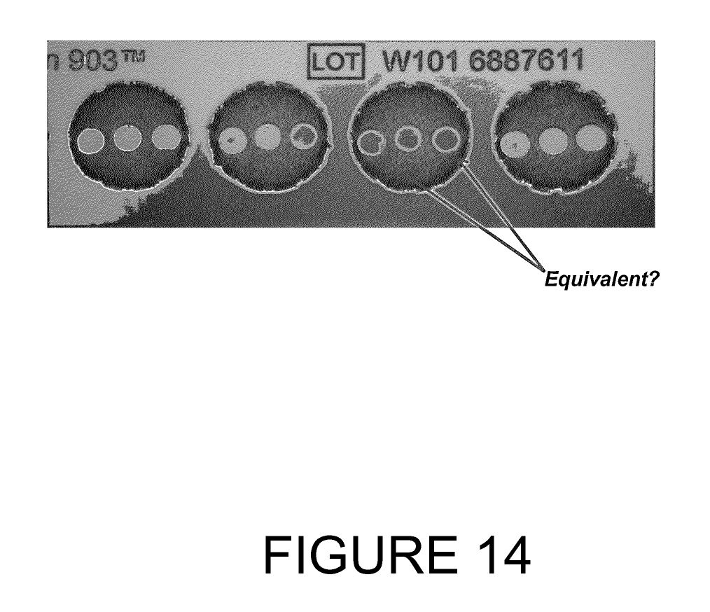

The NanoArray multiplex assay for the quantitative determination of IL-1β, IL-4, IL-6, IL-10 and TNF-α was used in an experiment to demonstrate that when the 3 mm punch samples were taken from a highly controlled area that reproducible data could be obtained from dry blood spot samples. In this Example, multiple samples are taken from the periphery of a DBS equidistant from the edge thereof (illustrated in FIGS. 2 and 14). Assuming that the blood drop spreads from the circles center to the edge, the concentration of analytes in punches taken in concentric rings around the center should be equivalent. Taking samples around the edge of the dried blood spot equidistant from the DBS edge would allow a number of equivalent samples to be taken.

The full details of the NanoArray assay procedure is given in the “48-well assay protocol” section of Example 1. The intra- and inter-run accuracy and precision were determined over 3 independent runs with 5 independent preparations of each QC samples prepared from the DBS samples. Each run contained a calibration curve, a blank and QCs covering the anticipated working range. The 3 runs were performed on 2 different days.

### Results

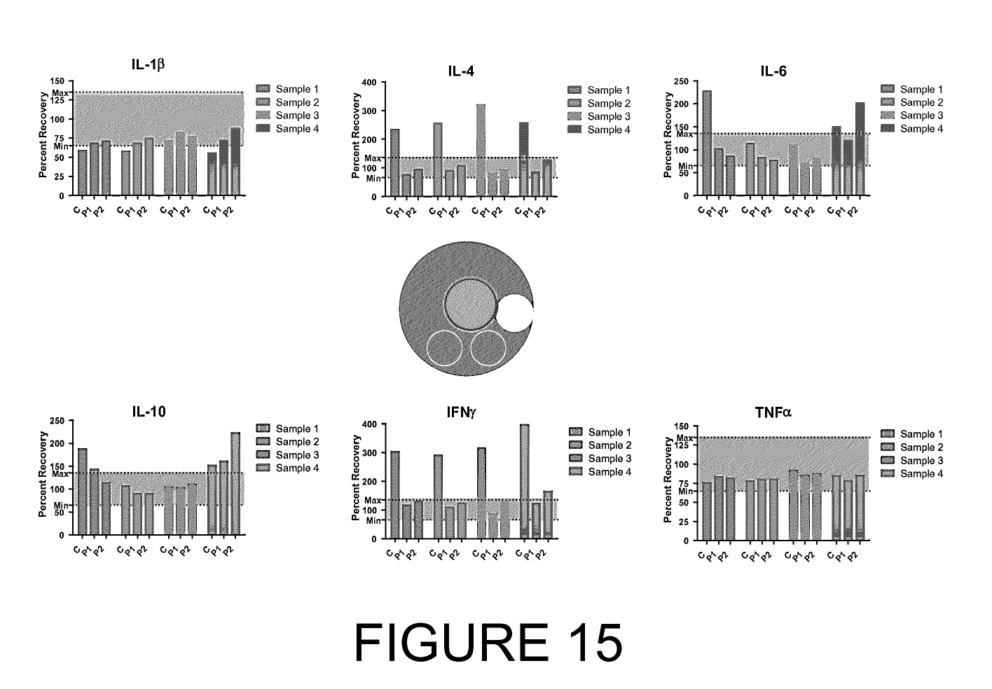

Assay validation is guided by strict requirements regarding sample accuracy, Precision, and reproducibility. Meeting validation requirements using DBS samples is particularly difficult in large part because of uneven analyte distribution and inconsistent sampling methods. In order to minimize variability in our DBS assay validation while still using the standard 3 mm circular sampling method, all samples, including standards and QC samples, were taken from a highly controlled area of the DBS sample. Using this method, the results of our validation experiments shown in Tables 3-8 and FIG. 15 reflect a highly reproducible assay method with Standard and QC Accuracy's between 80-120% and CV's (Precision)<25%.

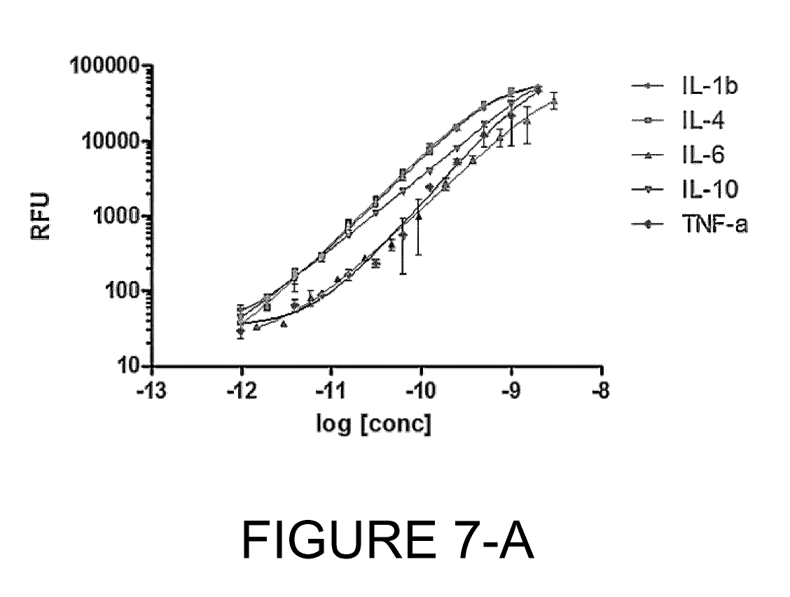

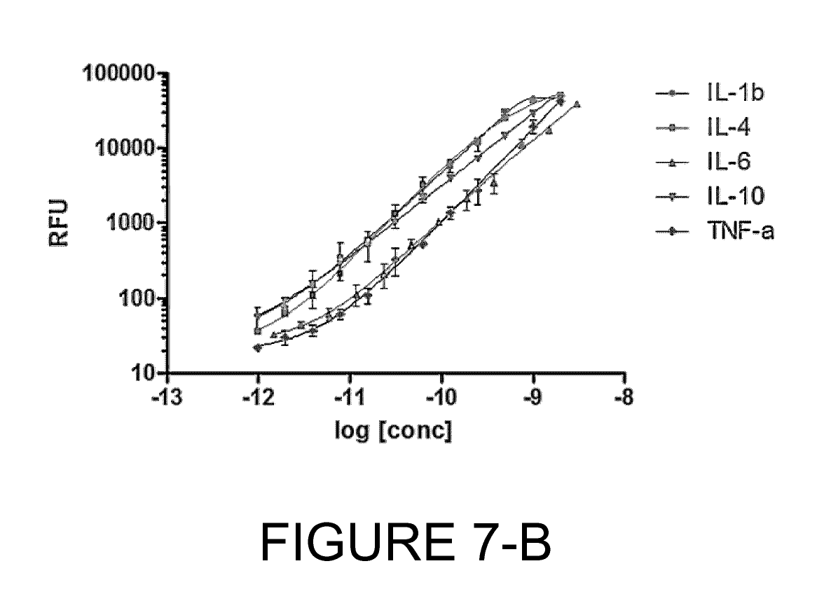

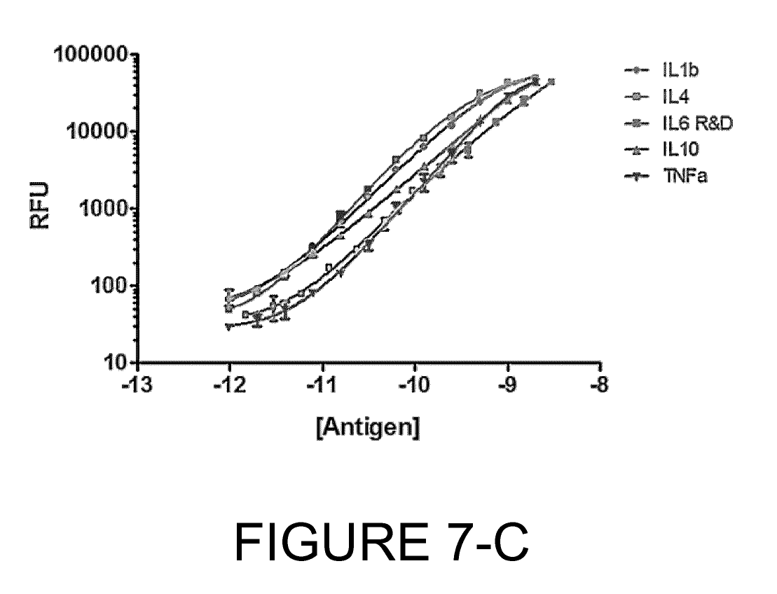

Tables 3-A to 3-C show data that demonstrate that a standard prepared from DBS can show accuracy that is reproducible over three experimental runs. See also FIGS. 7A, 7B, and 7C.

Tables 4-6 show data that demonstrate that quality control samples prepared from tightly controlled areas of DBS also show good reproducible results.

Table 7 shows data that demonstrate the accurate recovery of DBS standards back-calculated against block standard curve and adjusted for dilution. The DBS standard curve shows data obtained from DBS standards prepared by adding cytokines into a matrix containing human red blood cells and serum, followed by drying on filter cards and then elution for assay. The block standard curve shows data obtained from block standards prepared by adding cytokines into a buffer.

Taken together these data demonstrate that the use of a device to accurately sample DBS can have a significant effect on the quality of the data obtained, resulting in reproducible data that overcome the non-uniform distribution of cytokines in DBS.

### CONCLUSIONS

The inherent variability in DBS sample distribution on filter cards can make assaying DBS samples difficult and fraught with error. Our data suggest that carefully controlled sampling from the DBS cards can decrease this variability sufficiently that both standards and samples eluted from DBS cards can meet the strict validation criteria required of other sample types. Taking these results a step further, utilizing the sampling device described here would not only facilitate taking similarly controlled equivalent samples from the DBS sample, but samples taken in this way should also, upon assay, more accurately reflect the actual analyte concentration in the blood sample.

TABLE 3-A
% Accuracy (back-calculated from standards) and % CV's of standards run on three Slides over two days

| Conc. | IL-1β | | | | | | IL-4 | | | | | |
|---|---|---|---|---|---|---|---|---|---|---|---|---|
| pg/ml | Run 1 | Run 2 | Run 3 | Avg | % CV | % Acc | Run 1 | Run 2 | Run 3 | Avg | % CV | % Acc |
| 2000.0 | 1899.5 | nv | 1709.4 | 1804.4 | 7.5 | 90 | 1571.8 | 1721.4 | 1600.4 | 1631.2 | 4.9 | 82 |
| 1000.0 | 1692.6 | 907.2 | 1201.7 | 1067.2 | 14.0 | 107 | 1196.9 | 1212.6 | 1167.2 | 1192.2 | 1.9 | 119 |
| 500.0 | 489.6 | 541.3 | 502.6 | 511.2 | 5.3 | 102 | 535.5 | 514.1 | 592.0 | 547.2 | 7.4 | 109 |
| 250.0 | 236.6 | 222.5 | 227.2 | 228.8 | 3.1 | 92 | 231.5 | 219.2 | 220.0 | 223.6 | 3.1 | 89 |
| 125.0 | 136.6 | 117.4 | 122.2 | 125.4 | 8.0 | 100 | 113.0 | 122.0 | 116.4 | 117.1 | 3.9 | 94 |
| 62.5 | 61.3 | 69.4 | 65.7 | 65.5 | 6.2 | 105 | 63.9 | 67.7 | 64.9 | 65.5 | 2.9 | 105 |
| 31.3 | 29.5 | 31.0 | 31.7 | 30.7 | 3.7 | 98 | 32.7 | 31.7 | 31.5 | 32.0 | 2.1 | 102 |
| 15.6 | 16.3 | 13.7 | 15.8 | 15.3 | 9.1 | 98 | 17.6 | 16.1 | 16.4 | 16.7 | 4.9 | 107 |
| 7.8 | 7.2 | 9.2 | 8.4 | 8.2 | 11.9 | 106 | 7.2 | 7.0 | 7.7 | 7.3 | 4.9 | 94 |
| 3.9 | 4.5 | 3.8 | 3.5 | 3.9 | 13.8 | 100 | 4.0 | 3.9 | 3.6 | 3.8 | 5.3 | 97 |
| 2.0 | 1.7 | 1.6 | 1.8 | 1.7 | 6.9 | 87 | 1.7 | 2.2 | 2.1 | 2.0 | 12.1 | 104 |
| 1.0 | 1.0 | 1.1 | 1.1 | 1.1 | 3.2 | 109 | 1.0 | 0.9 | 0.9 | 0.9 | 8.4 | 96 |

TABLE 3-B

| Conc. | IL-10 | | | | | | TNF-a | | | | | |
|---|---|---|---|---|---|---|---|---|---|---|---|---|
| pg/ml | Run 1 | Run 2 | Run 3 | Avg | % CV | % Acc | Run 1 | Run 2 | Run 3 | Avg | % CV | % Acc |
| 2000.0 | 2030.7 | 1643.4 | 2009.3 | 1894.5 | 11.5 | 95 | 2120.6 | 1872.2 | 1991.6 | 1994.8 | 6.2 | 100 |
| 1000.0 | 1000.8 | 998.8 | 976.2 | 991.9 | 1.4 | 99 | 900.2 | 1001.0 | 1016.5 | 972.6 | 6.5 | 97 |
| 500.0 | 527.7 | 495.4 | 529.6 | 517.6 | 3.7 | 104 | 518.2 | 663.4 | 496.1 | 559.2 | 16.2 | 112 |
| 250.0 | 245.8 | 239.5 | 234.1 | 239.8 | 2.4 | 96 | 271.3 | 207.3 | 232.8 | 237.1 | 13.6 | 95 |
| 125.0 | 119.0 | 127.9 | 127.5 | 124.8 | 4.0 | 100 | 149.0 | 119.2 | 128.3 | 132.2 | 11.6 | 106 |
| 62.5 | 62.7 | 68.0 | 63.8 | 64.8 | 4.3 | 104 | 46.3 | 54.9 | 70.7 | 57.3 | 21.5 | 92 |
| 31.3 | 31.4 | 30.8 | 30.2 | 30.8 | 2.0 | 99 | 23.3 | 37.2 | 29.2 | 29.9 | 23.3 | 96 |
| 15.6 | 15.5 | 14.8 | 15.1 | 15.2 | 2.2 | 97 | 17.0 | 14.2 | 14.2 | 15.2 | 10.7 | 97 |
| 7.8 | 7.4 | 7.8 | 8.3 | 7.8 | 6.2 | 100 | 9.0 | 7.8 | 7.9 | 8.2 | 7.7 | 105 |
| 3.9 | 4.2 | 3.9 | 4.0 | 4.0 | 4.0 | 102 | 5.7 | 3.8 | 4.2 | 4.5 | 21.8 | 116 |
| 2.0 | 2.0 | 2.0 | 1.8 | 1.9 | 6.5 | 99 | — | 2.4 | 2.1 | 2.2 | 10.2 | 76 |
| 1.0 | 0.9 | 1.0 | 1.0 | 1.0 | 4.0 | 100 | — | — | — | — | — | — |

TABLE 3-C

| Conc. | IL-6 | | | | | |
|---|---|---|---|---|---|---|
| pg/ml | Run 1 | Run 2 | Run 3 | Avg | % CV | % Acc |
| 3000.0 | 3354.6 | 3023.4 | 2944.8 | 3107.6 | 7.0 | 104 |
| 1500.0 | 1401.6 | 1340.0 | 1560.2 | 1433.9 | 7.9 | 96 |
| 750.0 | 788.6 | 905.2 | 775.4 | 823.1 | 8.7 | 110 |
| 375.0 | 406.4 | 287.8 | 336.0 | 343.4 | 17.4 | 92 |
| 187.5 | 204.7 | 181.9 | 189.7 | 192.1 | 6.0 | 102 |
| 93.8 | 80.7 | 96.4 | 104.9 | 94.0 | 13.0 | 100 |
| 46.9 | 37.0 | 51.3 | 44.1 | 44.1 | 16.2 | 94 |
| 23.4 | 25.3 | 21.5 | 21.7 | 22.8 | 9.4 | 97 |
| 11.7 | 13.0 | 11.4 | 13.1 | 12.5 | 7.6 | 107 |
| 5.9 | 6.8 | 5.4 | 5.4 | 5.9 | 13.5 | 101 |
| 2.9 | 2.1 | 3.1 | 2.9 | 2.7 | 20.1 | 91 |
| 1.5 | 1.6 | 1.4 | 1.5 | 1.5 | 7.9 | 103 |

TABLE 4
ACCURACY
% Accuracy and % CV's of QC samples run on three slides

| IL-1β | | | | | IL-4 | | | | |
|---|---|---|---|---|---|---|---|---|---|
| Conc. | Obs Conc. | | | | Conc. | Obs Conc. | | | |
| (pg/mL) | (pg/mL)* | SD* | % CV | % Acc | (pg/mL) | (pg/mL)* | SD* | % CV | % Acc |
| 800 | 670.6 | 147.4 | 22 | 111.8 | 800 | 814.1 | 127.7 | 16 | 101.8 |
| 80 | 72.6 | 14.4 | 20 | 90.8 | 80 | 68.6 | 9.4 | 14 | 85.8 |
| 10 | 11.2 | 1.9 | 17 | 83.8 | 10 | 11.0 | 1.3 | 12 | 110.3 |
| IL-10 | | | | | TNF-a | | | | |
| Conc. | Obs Conc. | | | | Conc. | Obs Conc. | | | |
| (pg/mL) | (pg/mL)* | SD* | % CV | % Acc | (pg/mL) | (pg/mL)* | SD* | % CV | % Acc |
| 800 | 763.9 | 72.8 | 10 | 95.5 | 800 | 790.2 | 114.3 | 14 | 98.8 |
| 80 | 74.1 | 13.5 | 18 | 92.6 | 80 | 84.3 | 17.2 | 20 | 105.4 |
| 10 | 9.9 | 1.3 | 13 | 99.0 | 10 | 11.3 | 1.5 | 13 | 113.3 |

IL-6

| Conc. | Obs Conc. | | | |
|---|---|---|---|---|
| (pg/mL) | (pg/mL)* | SD* | % CV | % Acc |
| 1200.0 | 790.2 | 114.3 | 14 | 98.8 |
| 120.0 | 84.3 | 17.2 | 20 | 105.4 |
| 15.0 | 11.3 | 1.5 | 13 | 113.3 |

*Average and Standard Deviation are calculated from 15 replicates

TABLE 5
PRECISION
% CV of five QC samples run on each slide

| | Low QC | | | Mid QC | | | High QC | | |
|---|---|---|---|---|---|---|---|---|---|
| | average | stdev | % CV | average | stdev | % CV | average | stdev | % CV |
| Slide #1 | | | | | | | | | |
| IL-1b | 10.7 | 1.8 | 17 | 65.5 | 10.2 | 16 | 641.0 | 69.0 | 11 |
| IL-4 | 11.3 | 0.6 | 5 | 71.7 | 12.8 | 18 | 737.6 | 75.3 | 10 |
| IL-6 | 15.8 | 2.6 | 17 | 125.1 | 29.3 | 23 | 1181.4 | 159.6 | 14 |
| IL-10 | 10.8 | 0.7 | 6 | 75.4 | 14.5 | 19 | 718.0 | 65.0 | 9 |
| TNFa | 10.7 | 1.6 | 15 | 76.4 | 15.8 | 21 | 741.0 | 149.8 | 20 |
| Slide #2 | | | | | | | | | |
| IL-1b | 11.1 | 2.6 | 23 | 76.7 | 15.8 | 21 | 533.7 | 45.7 | 9 |
| IL-4 | 10.3 | 1.6 | 15 | 68.4 | 9.6 | 14 | 771.0 | 130.5 | 17 |
| IL-6 | 18.4 | 1.7 | 9 | 131.7 | 21.6 | 16 | 1214.5 | 118.4 | 10 |
| IL-10 | 9.5 | 1.1 | 12 | 64.5 | 12.2 | 19 | 759.1 | 50.7 | 7 |
| TNFa | 12.5 | 1.1 | 9 | 89.1 | 16.3 | 18 | 882.6 | 72.1 | 8 |
| Slide #3 | | | | | | | | | |
| IL-1b | 11.8 | 1.3 | 11 | 75.6 | 16.7 | 22 | 837.0 | 100.3 | 12 |
| IL-4 | 11.5 | 1.5 | 13 | 65.8 | 5.4 | 8 | 933.8 | 82.5 | 9 |
| IL-6 | 15.1 | 3.4 | 23 | 121.6 | 26.1 | 21 | 1147.8 | 112.3 | 10 |
| IL-10 | 9.3 | 1.5 | 16 | 82.3 | 8.8 | 11 | 814.7 | 76.6 | 9 |
| TNFa | 10.9 | 1.2 | 11 | 87.4 | 20.1 | 23 | 747.0 | 45.2 | 6 |

TABLE 6
QC samples slide-to-slide variability (% CV)

| | Low QC | | | Mid QC | | | High QC | | |
|---|---|---|---|---|---|---|---|---|---|
| | Ave | | | Ave | | | Ave | | |
| | (pg/ml) | SD | % CV | (pg/ml) | SD | % CV | (pg/ml) | SD | % CV |
| IL-1b | 11.2 | 0.6 | 5 | 72.6 | 6.1 | 8 | 670.6 | 153.8 | 23 |
| IL-4 | 11.0 | 0.6 | 6 | 68.6 | 3.0 | 4 | 814.1 | 105.0 | 13 |
| IL-6 | 16.4 | 1.7 | 11 | 126.2 | 5.1 | 4 | 1181.2 | 33.3 | 3 |
| IL-10 | 9.9 | 0.8 | 8 | 74.1 | 9.0 | 12 | 763.9 | 48.5 | 6 |
| TNFa | 11.3 | 1.0 | 9 | 84.3 | 6.9 | 8 | 790.2 | 80.1 | 10 |

TABLE 7

| | IL1-β | | | | IL-4 | | | | IL-6 | | | |
|---|---|---|---|---|---|---|---|---|---|---|---|---|
| | Mean | SD | C.V. | Rec | Mean | SD | C.V. | Rec | Mean | SD | C.V. | Rec |
| Block | 1742.6 | 61.8 | 3.5% | 87% | 1385.4 | 21.1 | 1.5% | 69% | 3087.6 | 203.2 | 6.6% | 103% |
| Standard | 1108.2 | 122.2 | 11.0% | 111% | 1144.5 | 32.9 | 2.9% | 114% | 1484.1 | 132.3 | 8.9% | 99% |
| Curve | 540.4 | 7.8 | 1.4% | 108% | 744.1 | 69.4 | 9.3% | 149% | 693.1 | 55.4 | 8.0% | 92% |
| | 234.4 | 2.4 | 1.0% | 94% | 217.3 | 47.6 | 21.9% | 87% | 385.6 | 5.7 | 1.5% | 103% |
| | 116.1 | 6.5 | 5.6% | 93% | 109.4 | 15.8 | 14.4% | 87% | 193.5 | 6.7 | 3.5% | 103% |
| | 65.2 | 2.3 | 3.6% | 104% | 60.9 | 5.9 | 9.6% | 98% | 103.4 | 1.0 | 1.0% | 110% |
| | 32.2 | 0.7 | 2.2% | 103% | 32.1 | 2.1 | 6.5% | 103% | 45.2 | 0.1 | 0.2% | 96% |
| | 16.1 | 0.6 | 3.5% | 103% | 16.7 | 0.7 | 4.2% | 107% | 21.7 | 1.3 | 6.2% | 93% |
| | 7.5 | 0.4 | 5.3% | 96% | 7.7 | 1.6 | 20.3% | 99% | 10.6 | 0.2 | 2.3% | 90% |
| | 4.0 | 0.2 | 4.3% | 101% | 3.9 | 0.4 | 9.5% | 99% | 6.6 | 0.0 | 0.4% | 112% |
| | 1.9 | 0.1 | 7.7% | 97% | 1.8 | 0.8 | 45.6% | 90% | 3.0 | 0.4 | 14.6% | 104% |
| | 1.0 | 0.2 | 17.2% | 104% | 1.1 | 0.0 | 4.5% | 109% | 1.4 | 0.3 | 23.3% | 94% |
| DBS | 1684.4 | 49.3 | 2.9% | 84% | 1342.4 | 44.2 | 3.3% | 57% | 2950.0 | 284.7 | 9.7% | 98% |
| Standard | 916.2 | 44.4 | 4.9% | 92% | 1054.2 | 24.6 | 2.3% | 105% | 1366.2 | 128.7 | 9.4% | 91% |
| Curve | 474.6 | 15.3 | 3.2% | 95% | 530.9 | 18.1 | 3.4% | 106% | 730.9 | 21.4 | 2.9% | 97% |
| | 223.8 | 24.0 | 10.7% | 90% | 222.8 | 6.1 | 2.7% | 89% | 398.0 | 3.2 | 0.8% | 106% |
| | 112.4 | 4.0 | 3.5% | 90% | 97.1 | 1.7 | 1.7% | 78% | 193.3 | 6.8 | 3.5% | 103% |
| | 67.2 | 3.7 | 5.5% | 108% | 57.0 | 1.0 | 1.7% | 91% | 109.7 | 0.8 | 0.7% | 117% |
| | 35.2 | 2.4 | 6.9% | 113% | 27.4 | 2.9 | 10.4% | 88% | 43.7 | 6.8 | 15.6% | 93% |
| | 16.6 | 0.1 | 0.9% | 106% | 13.2 | 0.0 | 0.1% | 84% | 22.6 | 3.3 | 14.4% | 96% |
| | 7.2 | 0.5 | 6.9% | 92% | 6.5 | 0.4 | 5.5% | 83% | 10.5 | 0.6 | 6.1% | 89% |
| | 4.3 | 0.1 | 3.3% | 110% | 3.4 | 0.1 | 1.8% | 86% | 6.6 | 0.6 | 8.9% | 112% |
| | 1.9 | 0.0 | 1.9% | 99% | 1.5 | 0.2 | 16.6% | 79% | 3.3 | 0.4 | 10.9% | 113% |
| | 1.4 | 0.5 | 37.1% | 147% | 0.6 | 0.5 | 92.9% | 58% | 2.8 | 0.1 | 4.8% | 183% |
| bl | 0.6 | | | | 0 | | | | 0.7 | | | |

| | IL-10 | | | | TNF-α | | | |
|---|---|---|---|---|---|---|---|---|
| | Mean | SD | C.V. | Rec | Mean | SD | C.V. | Rec |
| Block | 2029.3 | 1.2 | 0.1% | 101% | 2011.2 | 130.2 | 6.5% | 101% |
| Standard | 1050.3 | 177.4 | 16.9% | 105% | 998.1 | 85.6 | 8.6% | 100% |
| Curve | 466.0 | 21.0 | 4.5% | 93% | 493.2 | 4.9 | 1.0% | 99% |
| | 245.1 | 1.6 | 0.7% | 98% | 252.2 | 9.0 | 3.6% | 101% |
| | 119.9 | 4.1 | 3.4% | 96% | 126.2 | 1.8 | 1.4% | 101% |
| | 66.5 | 2.0 | 3.0% | 106% | 65.6 | 0.1 | 0.1% | 105% |
| | 31.9 | 0.4 | 1.2% | 102% | 29.9 | 0.8 | 2.8% | 96% |
| | 16.3 | 0.1 | 0.5% | 104% | 14.4 | 1.1 | 7.4% | 92% |
| | 8.2 | 1.3 | 15.7% | 105% | 7.5 | 1.0 | 13.2% | 96% |
| | 3.5 | 0.5 | 13.3% | 90% | 4.8 | 0.6 | 12.4% | 122% |
| | 1.8 | 0.1 | 7.3% | 94% | 2.0 | 0.7 | 32.9% | 104% |
| | 1.1 | 0.3 | 29.6% | 111% | 1.4 | | | 147% |
| DBS | 2257.9 | 8.4 | 0.4% | 113% | 2090.2 | 31.8 | 1.5% | 105% |
| Standard | 1275.8 | 135.2 | 10.6% | 128% | 1122.2 | 56.0 | 5.0% | 112% |
| Curve | 584.2 | 68.2 | 11.7% | 117% | 586.2 | 12.2 | 2.1% | 117% |
| | 298.7 | 47.8 | 16.0% | 119% | 322.7 | 10.0 | 3.1% | 129% |
| | 138.9 | 7.1 | 5.1% | 111% | 160.2 | 0.7 | 0.4% | 128% |
| | 85.2 | 1.8 | 2.1% | 136% | 98.0 | 4.7 | 4.8% | 157% |
| | 40.3 | 1.7 | 4.3% | 129% | 40.6 | 5.4 | 13.4% | 130% |
| | 17.7 | 2.3 | 12.8% | 113% | 20.6 | 0.6 | 2.9% | 132% |
| | 9.6 | 0.6 | 6.6% | 122% | 10.3 | 0.4 | 4.1% | 131% |
| | 6.5 | 0.4 | 5.8% | 5.8% | 6.7 | 1.0 | 14.5% | 171% |
| | 3.0 | 0.5 | 17.2% | 17.2% | 2.8 | 1.0 | 36.4% | 143% |
| | 1.3 | 0.4 | 30.6% | 135% | 2.3 | 0.1 | 4.2% | 231% |
| bl | 1.1 | | | | 1.1 | | | |

TABLE 8
Assay Results, RBC's + PBS-BSA
RFU Results

| | Sample 1 | | | Sample 2 | | | Sample 3 | | | Sample 4 | | |
|---|---|---|---|---|---|---|---|---|---|---|---|---|
| | | Periphery | Periphery | | Periphery | Periphery | | Periphery | Periphery | | Periphery | Periphery |
| | Center | 1 | 2 | Center | 1 | 2 | Center | 1 | 2 | Center | 1 | 2 |
| IL-1b | 2661 | 3353 | 3276 | 2560 | 3332 | 3373 | 3070 | 3539 | 3486 | 2051 | 3035 | 3927 |
| IL-4 | 4807 | 1563 | 2072 | 5635 | 1936 | 2311 | 6693 | 1498 | 1769 | 4226 | 1652 | 2622 |
| IL-6 | 676 | 308 | 239 | 300 | 230 | 220 | 276 | 212 | 226 | 363 | 246 | 466 |
| IL-10 | 3287 | 2478 | 1705 | 1677 | 1536 | 1290 | 1490 | 1447 | 1703 | 2316 | 2187 | 3519 |
| IFN-g | 7779 | 2682 | 3212 | 7657 | 2758 | 3141 | 8570 | 2007 | 3136 | 9347 | 2812 | 3767 |
| TNF-a | 1114 | 1248 | 1307 | 1168 | 1333 | 1385 | 1444 | 1370 | 1210 | 1226 | 1165 | 1347 |

| Percent signal change from center to periphery | | | | | | | | | |
|---|---|---|---|---|---|---|---|---|---|
| | Sample 1 | | Sample 2 | | Sample 3 | | Sample 4 | | Average |
| IL-1b | 21 | 19 | 23 | 24 | 13 | 12 | 32 | 48 | 24 |
| IL-4 | −208 | −132 | −191 | −144 | −347 | −278 | −156 | −61 | −190 |
| IL-6 | −119 | −182 | −30 | −37 | −30 | −22 | −47 | 22 | −56 |
| IL-10 | −33 | −93 | −9 | −30 | −3 | 12 | −6 | 34 | −16 |
| IFN-g | −190 | −142 | −178 | −144 | −327 | −173 | −232 | −148 | −192 |
| TNF-a | 11 | 15 | 12 | 16 | −5 | −19 | −5 | 9 | 4 |

### Example 3

### Excising Sector-Shaped Samples from DBS

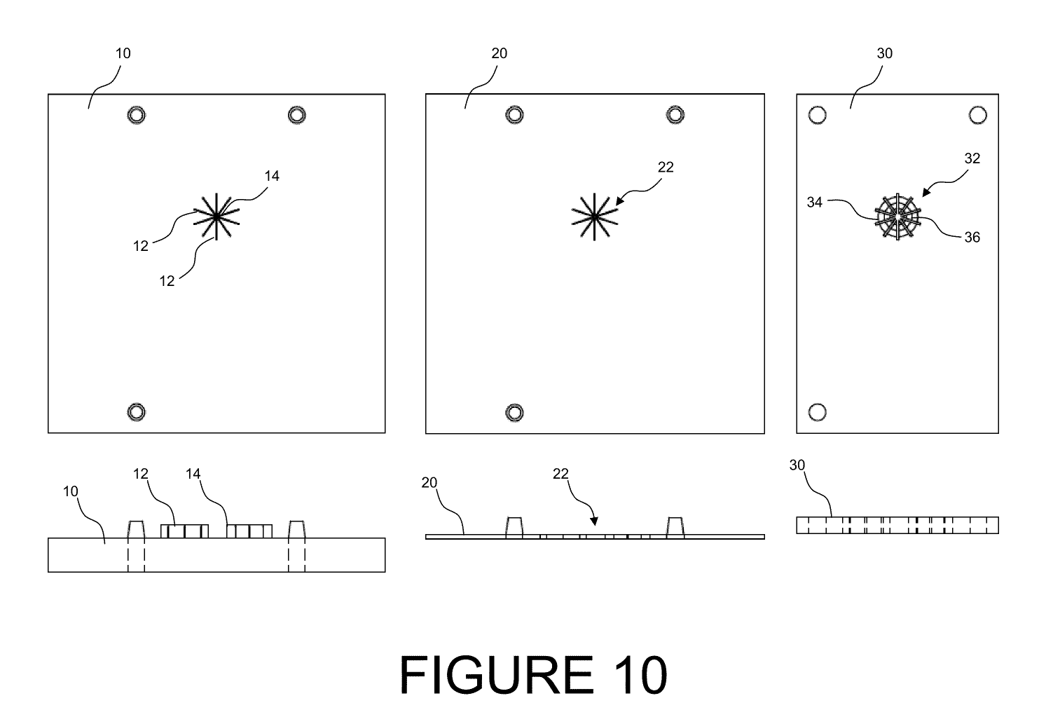

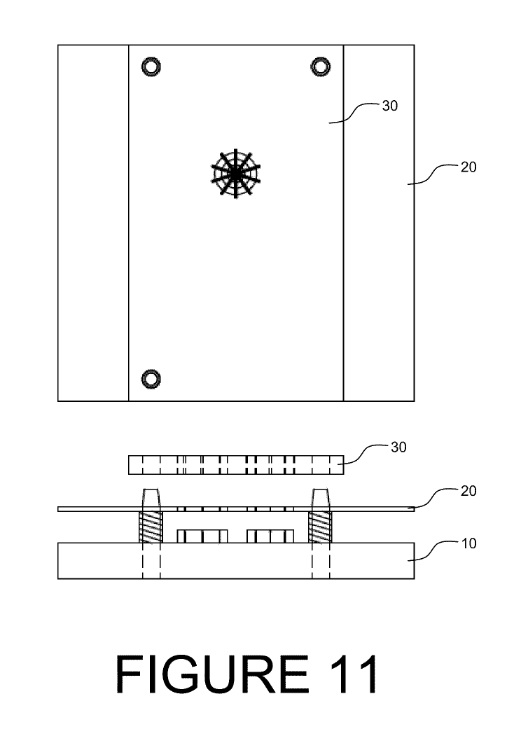

Using the apparatus shown in FIGS. 9-11, sector-shaped samples of equal size can be excised from DBS. As shown in FIG. 10, in one embodiment, the apparatus can comprise a steel punch plate, a die plate, and a polycarbonate alignment sheet. As shown in FIG. 11, in the basic assembly of the apparatus, the steel die plate is placed on top of the steel punch plate, and the polycarbonate alignment sheet is placed on top of the steel die plate. As shown in FIG. 9, during operation of the apparatus, a DBS card is positioned between the polycarbonate alignment sheet and the steel die plate, using rings on the polycarbonate alignment sheet to position the DBS evenly over punch, in order to cut equal sized samples from the DBS. Once aligned, the polycarbonate alignment sheet is held down to hold the DBS card in place and the polycarbonate alignment sheet/steel die plate combination are pressed down over the steel punch plate to cut the DBS into sector-shaped segments of equal size. Because of the possible variability of the DBS diameter, an additional step is taken to completely separate the cut segments from the DBS card for assaying at least one biomolecule in subsequent steps. The additional step involves using a circle punch with a diameter chosen to correspond to the diameter of the particular DBS.

What is claimed is:

1. A method comprising:
providing a substrate comprising at least one dried blood spot (DBS), wherein said DBS comprises at least one biomolecule distributed on the substrate in a gradient pattern;
excising at least one sector-shaped sample from the DBS; and
optionally, assaying the biomolecule in the sector-shaped sample.

2. The method of claim 1, wherein the substrate comprises at least one sample deposition area for depositing the DBS.

3. The method of claim 1, wherein the substrate is a filter paper.

4. The method of claim 1, wherein the substrate is a Whatman 903 card.

5. The method of claim 1, wherein the DBS is prepared from whole blood.

6. The method of claim 1, wherein the DBS is prepared from a synthetic blood matrix.

7. The method of claim 1, wherein the DBS is prepared from a synthetic blood matrix comprising at least one protein carrier.

8. The method of claim 1, wherein the biomolecule is a protein.

9. The method of claim 1, wherein the biomolecule is a cytokine.

10. The method of claim 1, wherein the biomolecule is a cytokine which is an IL-1β, an IL-4, an IL-6, an IL-10, or a TNF-α.

11. The method of claim 1, wherein the biomolecule is more concentrated at the center of the DBS than at the periphery.

12. The method of claim 1, wherein the biomolecule is more concentrated at the periphery of the DBS than at the center.

13. The method of claim 1, wherein the sector-shaped sample is excised by a sharp cutting tool.

14. The method of claim 1, wherein the sector-shaped sample is excised with use of the apparatus of claim 32.

15. The method of claim 1, wherein the sector-shaped sample is excised radiating from the center to the circumference of the DBS.

16. The method of claim 1, wherein the sector-shaped sample consists of a sector bounded by two radii and an arc lying between the two radii.

17. The method of claim 1, wherein two or more sector-shaped samples of equal size and shape are excised from the DBS.

18. The method of claim 1, wherein eight or more sector-shaped samples of equal size and shape are excised from the DBS.

19. The method of claim 1, wherein the assaying step is carried out and the step of assaying the biomolecule comprises measuring the amount of the biomolecule.

20. The method of claim 1, wherein assaying step is carried out and the step of assaying the biomolecule comprises measuring the amount of the biomolecule, and wherein the amount of the biomolecule is measured in two or more sector-shaped samples.

21. A method comprising:
providing a substrate comprising at least one dried spot of a bio-fluid, wherein said dry spot comprises at least one biomolecule distributed on the substrate in a gradient pattern;
excising at least one sector-shaped sample from the dried spot; and
measuring the amount of the biomolecule in the sector-shaped sample.

22. The method of claim 21, wherein the substrate is a filter paper.

23. The method of claim 21, wherein the biomolecule is a protein.

24. The method of claim 21, wherein the biomolecule is selected from the group consisting of a nucleic acid, polysaccharide, lipid, vitamin, hormone, and neurotransmitter.

25. The method of claim 21, wherein the bio-fluid is an animal body fluid selected from the group consisting of blood, tear, saliva, lymph, gastrointestinal fluid and urine.

26. The method of claim 21, wherein the bio-fluid is selected from the group consisting of plant xylem fluid, plant phloem fluid, and liquid culture of bacteria.

27. The method of claim 21, wherein the biomolecule is more concentrated at the center of the dried spot than at the periphery.

28. The method of claim 21, wherein the biomolecule is more concentrated at the periphery of the dried spot than at the center.

29. The method of claim 21, wherein the sector-shaped sample is excised by a sharp cutting tool.

30. The method of claim 21, wherein the sector-shaped sample consists of a sector bounded by two radii and an arc lying between the two radii.

31. The method of claim 21, wherein two or more sector-shaped samples of equal size and shape are excised from the dried spot.

32. An apparatus for excising at least one sample from a DBS, comprising:
a punch plate comprising at least two cutting arms meeting each other at an anchor point;
a die plate on top of said punch plate comprising an aperture for said cutting arms to pass through;
an alignment sheet on top of said die plate comprising a sample aligner directly above said cutting arms and said aperture; and
wherein said apparatus is adapted such that (i) said DBS can be securely placed between the die plate and the alignment sheet and aligned with said sample aligner, and (ii) the die plate and the punch plate can move toward each other allowing said cutting arms to pass through said aperture and excising said DBS.

33. The apparatus of claim 32, wherein the length of each cutting arm is about 0.1-0.5 inch.

34. The apparatus of claim 32, wherein the length of each cutting arm is about 0.2-0.4 inch.

35. The apparatus of claim 32, wherein the punch plate comprises a sufficient number of cutting arms meeting each other at the anchor point to cut the DBS into two, three, four, five, six, eight, ten or twelve sectors of equal size.

36. The apparatus of claim 32, wherein the cutting arms are made of metal, polymer, or silicon-based material.

37. The apparatus of claim 32, wherein the cutting arms are made of steel.

38. The apparatus of claim 32, wherein the alignment sheet is made of polycarbonate.

39. The apparatus of claim 32, wherein the aligner comprises at least one outer ring centered at the anchor point.

40. The apparatus of claim 32, wherein the aligner comprises at least one outer ring and at least one inner ring both centered at the anchor point, wherein the outer ring and the inner ring are concentric.

41. The apparatus of claim 32, wherein the punch plate further comprises at least one cutting skirt connecting the at least two cutting arm.

42. The apparatus of claim 32, wherein the punch plate further comprises at least one arc-shaped cutting skirt connecting the at least two cutting arm, wherein the cutting arms and the cutting skirt operate together for excising a geometrical-sector-shaped sample.

43. A method comprising:
providing a substrate comprising at least one dried blood spot (DBS), wherein said DBS comprises at least one biomolecule distributed on the substrate in a non-uniform pattern;
excising at least one sector-shaped sample from the DBS; and
optionally, assaying the biomolecule in the sector-shaped sample.

44. A method comprising:
providing a substrate comprising at least one dried spot of a bio-fluid, wherein said dried spot comprises at least one biomolecule distributed on the substrate in a non-uniform pattern;
excising at least one sector-shaped sample from the dried spot; and
measuring the amount of the biomolecule in the sector-shaped sample.

45. A method comprising:
evaluating at least one biomolecule disposed on a substrate, wherein the evaluation is carried out on at least two sector-shaped portions of the substrate of approximately equal size.

46. The method of claim 1, wherein the substrate comprises at least one sample deposition area that is not pre-cut before the DBS is deposited.

47. The method of claim 46, wherein the substrate is a filter paper, and wherein the sample deposition area is a pre-marked circular collection area on the filter paper.
